(19) United States
(12) Patent Application Publication
(10) Pub. No.: US 2013/0117103 A1
(43) Pub. Date: May 9, 2013

(54) UNIVERSAL CONTROL

(71) Applicant: InsightExpress, LLC, Stamford, CT (US)

(72) Inventors: Jerome Shimizu, Stamford, CT (US); Marc Ryan, Darien, CT (US)

(73) Assignee: INSIGHTEXPRESS, LLC, Stamford, CT (US)

(21) Appl. No.: 13/672,384

(22) Filed: Nov. 8, 2012

Related U.S. Application Data
(60) Provisional application No. 61/557,202, filed on Nov. 8, 2011.
(60) Provisional application No. 61/610,161, filed on Mar. 13, 2012.

(51) Int. Cl. G06Q 30/02

(52) U.S. Cl. 705/14.44; 705/14.41

(57) ABSTRACT

Techniques are provided for establishing a control group from members a given population by identifying, for each member of the test group, an “unexposed twin”. In general, the unexposed twin of a test group member is the person that is most similar to the test group member, from among the members of the population that have not been exposed to the relevant marketing efforts. Preferably, the twins of each member of the population are pre-computed by mapping relevant attributes of the member to N-dimensional space. The “twin mapping” thus produced is then used to identify a control group candidate when a member of the population becomes exposed to marketing efforts for which testing is being performed.

### CROSS-REFERENCE TO RELATED APPLICATIONS; BENEFIT CLAIM

This application claims the benefit of Provisional Application No. 61/557,202, filed Nov. 8, 2011, and of Provisional Application No. 61/610,161, filed Mar. 13, 2012, the entire contents of both of which is hereby incorporated by reference as if fully set forth herein, under 35 U.S.C. §119(e).

### FIELD OF THE INVENTION

The present invention relates to techniques for measuring effectiveness of marketing and, more specifically, for automatically identifying individuals for a control group for a test of marketing effectiveness.

### BACKGROUND

It is critical for companies to be able to accurately assess the effectiveness of their marketing efforts. One common approach to measure marketing effectiveness involves comparing behavior of those exposed to marketing efforts (the “test group”) to behavior of those not exposed to the marketing efforts (the “control group”). While being a theoretically ideal approach to effectiveness measurement, this approach makes one critical assumption: that the control group represents what would have happened to the test group in the absence of the exposure to the marketing efforts.

In real world industry implementations, efforts to ensure that the behavior of the control group accurately reflects the behavior of the test group without exposure often only amounts to ensuring that the control group has visited the same website that a test ad was placed on. But matching only on website does not make a good control. One of the major pitfalls of this approach comes with the introduction of ad targeting. The consumers targeted in the campaign may not be at all representative of the overall site. Comparisons of highly targeted consumers to general site visitors, or worse, comparisons of them to consumers classified as “remnant” bonus inventory, can easily result in misleading research conclusions.

Based on the foregoing, it would be desirable to improve the accuracy of automated marketing effectiveness tests by employing techniques that increase the likelihood that behavior of the control group reflects how the test group would behave in the absence of exposure to the marketing efforts.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram illustrating how attribute values may be mapped to integer coordinates, according to an embodiment;

FIG. 2 is a diagram of a table that stores pre-computed space-location values, and “closest neighbor” information, according to an embodiment;

FIG. 3 is a flowchart that illustrates on-the-fly identification of an “unexposed twin” in response to detecting that a user has been exposed to marketing efforts; and

FIG. 4 is a block diagram illustrating a computer system upon which embodiments may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Techniques are provided for establishing a control group from members a given population by identifying, for each member of the test group, an “unexposed twin”. In general, the unexposed twin of a test group member is the person that is most similar to the test group member, from among the members of the population that have not been exposed to the relevant marketing efforts.

In one embodiment, the twins of each member of the population are pre-computed by mapping relevant attributes of each member to N-dimensional space. The “twin mapping” thus produced is then used to identify a control group candidate when a member of the population becomes exposed to marketing efforts for which testing is being performed. Specifically, in response to detecting that a member of the population has been exposed to marketing efforts, the twin mapping data is inspected to identify the unexposed twin of that member. In one embodiment, the unexposed twin is the closest other member, within the N-dimensional space, that has not been exposed to those marketing efforts. Post-exposure behavior of the exposed member is then compared to the behavior of the unexposed twin to determine effectiveness of the marketing efforts.

### Attribute Value Collection

As mentioned above, the twin mapping is produced by mapping relevant attributes of each member of a population to N-Dimensional-Space. The attributes whose values are used to perform the mapping may be any attributes that are deemed relevant to establishing similarity. The attributes may include, for example, any number of demographic attributes, geographic attributes, and behavioral attributes. For the purpose of explanation, an example shall be given in which the relevant attributes are:

Demographics: Age, gender, marital status, number of children.

Geographies: region

Behavioral: frequency of using service X, frequency of using service Y

However, these attributes and attribute categories are merely exemplary, and the techniques described herein are not limited to any particular attributes or attribute categories. The actual attributes that are relevant to a particular marketing effectiveness test may vary from test to test, depending on the nature of the goods or services being marketed. For example, the user's “hair color” attribute may be particularly relevant to test marketing efforts for a hair coloring product, but far less relevant when testing marketing efforts for legal services.

According to one embodiment, attribute values for the relevant attributes are collected for each member of the population. A variety of techniques may be used to collect the attributes. For example, the population may be users that have registered with an effectiveness testing service, and the testing service may cause users to enter profile information as part of the registration process. As another example, the testing service may obtain the attribute information from other sources, such as user profiles of other services, social networks, etc.

In other cases, attribute information may be gathered by monitoring behavior of the users. For example, attributes may include which web sites a user visits, and the frequency of those visits. To collect information about web-site usage attributes, tags may be added to the pages of web sites so that usage information may be collected using cookie technology. Alternatively, users may install a toolbar or other plug-in into their browser, where the toolbar reports to the effectiveness testing service which websites the user is visiting. Website usage may also be tracked by “meters”, which are configured to monitor and report which websites are visited by users of the device on which the meter is installed.

Similarly, attributes may include the television programs that a user watches. Attribute value collection for television viewing behavior may be collected, for example, by the set-top boxes through which the users receive the programming.

### Attribute-Value-to-Integer Mappings

As mentioned above, the twin mapping used to identify unexposed twins is generated by mapping members of the population to N-Dimensional-Space based on their attribute values. According to one embodiment, before members are mapped to N-Dimensional-Space based on their attribute values, the value of each attribute is mapped to a spatial coordinate represented by an integer. For example, for the attribute age, ages 0-19 may be mapped to 0, ages 20-29 may be mapped to 1, ages 30-49 may be mapped to 2, and ages 50+ may be mapped to 3.

In the example given above, a numeric value (age) is mapped to an integer. In one embodiment, non-numeric attribute values are also mapped to integers. For example, for the gender attribute, female is mapped to 0 and male is mapped to 1. Various techniques may be used to map non-integer attributes to integer coordinates. For example, in the case where “web-sites visited” is used as a factor to determine similarity between users, one way of mapping the “web-sites visited” information to integer coordinates is to treat each web site as a distinct attribute. Because each site is a distinct attribute, the mapping process may assign the attribute for a given website the integer coordinate of “0” to users who have not visited the site, and the integer coordinate of “1” to users who have visited the site.

As an alternative, to capture the frequency with which each user visits a particular site, the coordinate value assigned to the attribute may be the number of times the user has ever visited the site, or has visited the site within a particular time period. For example, a user that has visited site X one hundred times within the last year may be assigned the integer coordinate “100” for the attribute that corresponds to visiting site X.

Preferably, the attribute-value-to-integer mapping is established such that the closer the attribute values, the closer the integers to which the attribute values are mapped. For example, for the attribute “user of social network service X”, the possible values may be “non-user”, “infrequent-user” and “frequent-user”. Consequently, the integer to which “non-user” is mapped should be closer to the integer to which “infrequent-user” is mapped than it is to the integer to which “frequent-user” is mapped.

### Generating the Space-Location of Users

The position to which the attribute values of a particular user map, within the N-Dimensional-Space, is referred to herein as the “space-location” of the user. According to one embodiment, the space-location of a user is generated by combining the integers to which the user's attribute values map, to form a single value that represents the user's space-location.

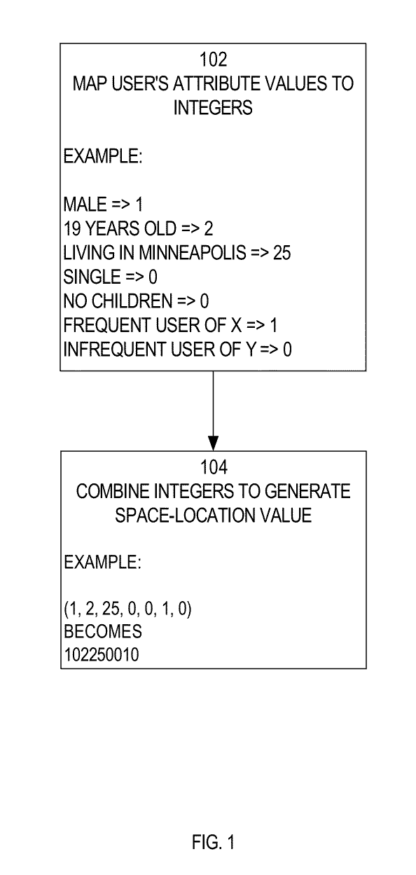

FIG. 1 is a flowchart that illustrates how such a space-location value may be generated, according to an embodiment of the invention. Referring to FIG. 1, at step 102, each of a user's attribute values are mapped to an integer, according to the attribute-value-to-integer mappings discussed above. The example given in FIG. 1 involves a user (USER1) who is male, 19 years old, single, living in Minneapolis, with no children, who frequently uses online service X, and infrequently uses online service Y. In the illustrated example, the user's attributes are mapped to integers as follows:

MALE=>1

19 YEARS OLD=>2

LIVING IN MINNEAPOLIS=>25

SINGLE=>0

NO CHILDREN=>0

FREQUENT USER OF X=>1

INFREQUENT USER OF Y=>0

In step 104, the integers to which the user's attribute values map are combined to form a single value “102250010”. This single value represents the user's space-location.

When N integer-coordinate values are combined in this manner, the numeric difference between two space-location values may be treated as the distance between the two space-locations. Thus, the distance between USER1 at space-location 102250010 and another user at space-location 102260010 would be 10000.

One benefit of representing space-locations in this manner is the relative simplicity of computing distances. However, this space-location format necessarily gives the attributes associated with the higher-order digits significantly more weight than attributes associated with lower-ordered digits. For example, a USER2 that is identical to USER1 but for being a frequent user of service Y would have the space-location 102250011, and therefore only have a distance of 1 from USER1. On the other hand, a USER3 that is identical to USER1 but for being female would have space-location 002250010, and therefore have a distance of 100000000 from USER1.

Therefore, embodiments that combine integer coordinates in this manner do so by mapping the coordinate values of the most significant characteristics (the characteristics deemed to have the highest predictive power) to the high-order positions of the space-location values, and the less significant characteristics to the low-order positions of the space-location values.

The space-location generation technique illustrated in FIG. 1 is merely one technique for mapping characteristics to a position in N-dimensional space. The specific technique used may vary from implementation to implementation. Numerous alternative techniques which may be used instead of or in conjunction with this technique shall be described in greater detail hereafter.

### Generating the Twin Mapping

Once the space-location of each user in the population has been computed, the space-location of each user is compared to the space-location of each other user to determine the distance between each user and each other user. According to one embodiment, these distances are computed before users are exposed to marketing efforts. Because they are pre-computed, when a user is exposed to a marketing effort (thereby becoming a member of the test group), minimal computing is required to locate that member's nearest neighbors in the N-Dimensional-Space.

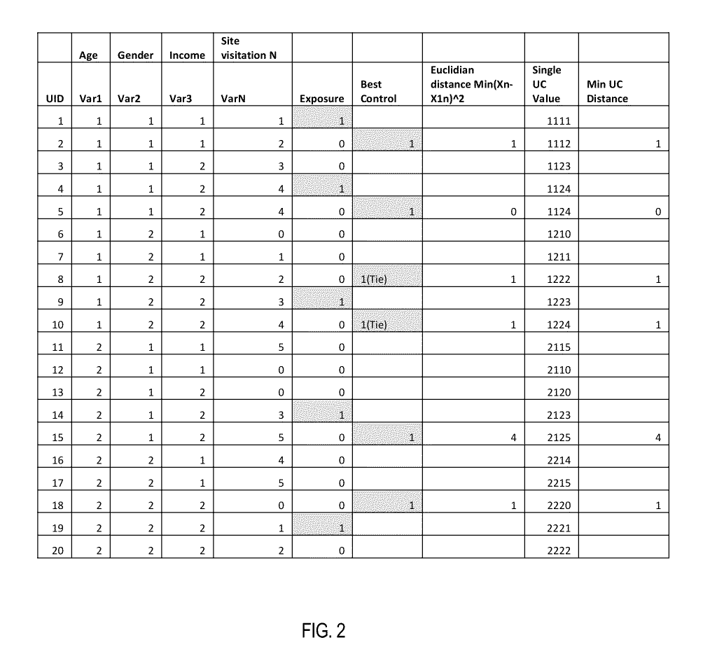

Referring to FIG. 2, it is a diagram showing a table in which the “unexposed twin” of various users has been pre-computed based on pre-computed distances between members of the population. Referring to FIG. 2, it illustrates a table in which each row corresponds to a distinct member of the population. In each row, the value in the UID column contains a unique user ID for the user represented by the row. The Age, Gender, Income, and Site Visitation columns respectively contain the integer coordinate values to which each user's attribute values map. For example, the user with UID 10 has an age value that maps to 1, a gender value that maps to 2, an income value that maps to 2, and a site visitation value that maps to 4.

The “Single UC Value” column contains the single space-location value generated by concatenating the individual integer coordinate values of each user. For example, the individual coordinate values of the user with UID 10 produce 1224 when concatenated.

By comparing the “Single UC Value” of each member to the “Single UC Value” of each other member, the distances between each member and each other member may be computed. In one embodiment, the table in FIG. 2 includes columns (not shown) for storing the distances of each member to each other member. Storage of all computed distances would require M−1 additional columns, where M is the size of the population used for marketing effectivness tests.

Unfortunately, with very large populations, it is not practical nor necessary to maintain all of the distance values. Therefore, according to one embodiment, the effectiveness testing service only maintains data that indicates, for each user, the N closest other users, wherein N is a value that is significantly smaller than the number of members in the entire population. For example, in a population of millions, N may be 5. When a particular user is exposed to a marketing effort, the N closest neighbor information is sufficient to find the unexposed twin of the particular user, as long as at least one of the N closest neighbors has not been exposed to the marketing effort being tested.

Referring again to FIG. 2, the table also includes an “exposure” column and a “Min UC Distance” column. The “exposure” column indicates whether a user has been exposed to the marketing effort whose effectiveness is being tested. In the example illustrated in FIG. 2, the users associated with UIDs 1, 4, 9, 14 and 19 have been exposed to the marketing effort. Consequently, those users constitute the “test group”.

Based on the between-user distances, the unexposed twin of each of the members in the test group have been identified. Specifically, for the user with UID 1, the unexposed twin is the user with UID 2, and the distance between the two users is 1 (as illustrated in the Min UC Distance column of the row associated with UID 2). Similarly, for the user with UID 4, the unexposed twin is the user with UID 5, where the distance between the two users is 0. For the user with UID 9, the unexposed twin may be either the user with UID 8 or the user with UID 10. Either may be used, because the distance between the user with UID 9 and each of them is the same (i.e. 1).

For the user with UID 14, the unexposed twin is the user with UID 15, where the distance between the two users is 4 (in this example, the square of the difference between the UC values is treated as the distance). For the user with UID 19, the unexposed twin is the user with UID 18, where the distance between the two users is 1.

In the example population illustrated in FIG. 2, the closest neighbor to each exposed member is an unexposed member. However, in some situations, the closest neighbor to an exposed member may be another exposed member. When identifying the unexposed twin of an exposed member, all such exposed members are skipped. Thus, the unexposed twin of an exposed member is the closest unexposed neighbor of the member, but not necessarily the closed neighbor of the member.

### Control Groups of Unexposed Twins

As mentioned above, distances between members of a population are used to determine the “closest neighbors” of each member within the N-Dimensional-Space that corresponds to the attributes of members of the population. These pre-computed distances can be used to quickly determine the “unexposed twin” of any member of the population that is exposed to marketing efforts for which effectiveness testing is being performed.

Referring to the data illustrated in FIG. 2, in response to detecting that the user associated with UID 1 has been exposed to the marketing efforts being tested, thereby becoming a member of the test group, the pre-calculated information may be inspected to identify that user's closest neighbor that has not been exposed to the marketing efforts. In the present example, the user associated with UID 2 would be identified as the unexposed twin of the user associated with UID 1. In response to determining that the user associated with UID 2 is the unexposed twin, the user associated with UID 2 would be added to the control group. A control group formed in this manner includes one “twin” for each member of the test group.

Each unexposed twin of a test group member is selected based on similarity of attributes that are predictive of behavior. Consequently, each unexposed twin is likely to behave as the corresponding test group member would have behaved if the test group member had not been exposed to the marketing efforts. Since this is true for each unexposed twin individually, the likelihood that the behavior of a control group formed of unexposed twins accurately reflects what the test group would have done if unexposed to the marketing efforts is significantly higher than it would be if the control group were selected in another way.

### Effectiveness Testing Using Unexposed-Twin Control Groups

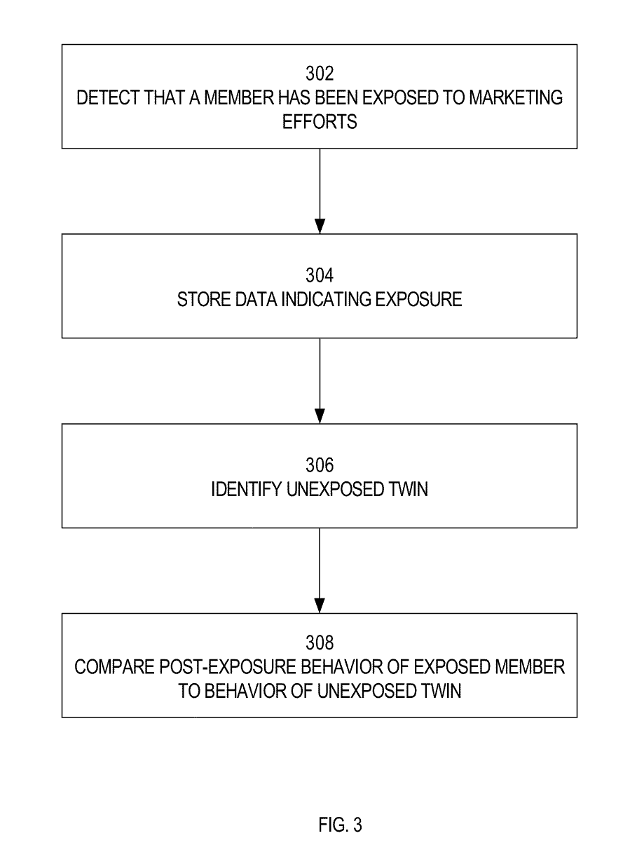

FIG. 3 is a block diagram for effectiveness testing using unexposed-twin control groups, according to an embodiment of the invention. As mentioned above, the space-locations of members of a population have been pre-computed, along with the distances between the members. At step 302, it is determined that a member of the population (USER1) has been exposed to marketing efforts. This detection may be performed in any one of a variety of ways. Various techniques for detecting exposure are described in greater detail hereafter.

Regardless of how exposure is detected, at step 304, data is stored by the effectiveness testing service to indicate that USER1 was exposed. Data that indicates that a user was exposed communicates both that the user is in the test group, and that the user is disqualified from being the unexposed twin of another member of the test group. If USER1 was already in the control group as an unexposed twin of another member of the test group, USER1 is removed from the control group and a new unexposed twin is added to the control group for that other member.

At step 306, an unexposed twin is found for USER1. As explained above, the pre-computed distances are used to identify the nearest neighbor of USER1 that has not been exposed to the marketing efforts. For the purpose of illustration, it shall be assumed that USER2 is the unexposed twin of USER1. Consequently, USER2 is added to the control group in response to USER1 becoming a member of the test group.

Once the unexposed twin is added to the control group, the behavior of the unexposed twin is compared to the post-exposure behavior of the exposed member (step 308). In the present example, the post-exposure behavior of USER1 is compared to the behavior of USER2 to determine the effectiveness of the marketing efforts. Any one of a variety of mechanisms may be used to obtain and compare the behavior of users. Various mechanisms for obtaining and comparing behavior information are described hereafter.

### Detecting Exposure

The manner of detecting exposure may be based on a variety of factors, including the nature of the marketing effort. For example, if the marketing effort is an online ad campaign, detecting exposure may involve adding a tag to an advertisement. Based on cookie technology, when a browser renders a page that includes the advertisement, the tag may cause a message to be sent to an effectiveness testing service. The message may include data used to identify which member of the population was exposed to the ad.

As another example, the marketing effort may be an advertisement presented by a mobile application running on mobile phones and/or tablets. In such an embodiment, the mobile application may be configured with code to send a message that reports the exposure to the effectiveness testing service. The message may indicate, for example, the user id of the owner of the mobile device, and an identifier of the advertisement to which the user was exposed.

The marketing efforts that may be tested using the techniques described herein may include television advertising. In the case of television advertising, detection may be performed, for example, by configuring set-top boxes to communicate to the effectiveness testing service which advertisements are displayed to the users that are receiving their television signal through the set-top boxes.

As another example, if the marketing effort is a live demonstration, viewers of the demonstration may be asked to provide their email addresses. If an email address thus provided matches an email address of a member of the population, that member is treated as having been exposed.

Exposure to printed material advertising may be detected in a variety of ways. For example, in one embodiment, the print advertising may request that readers enter a particular code on a particular website to receive some benefit. In response to receiving the code at the particular website, the website may report to the effectiveness testing service that the user that submitted the code was exposed to the advertisement that included the code. As another example, the advertisement may request the user to send a particular text message to a particular number. The service that receives the text message may report to the effectiveness testing service that the user sent the text message has been exposed to the corresponding advertisement.

### Obtaining Behavior Information

As mentioned above, effectiveness is measured by comparing the post-exposure behavior of the test group members to the behavior of the control group members. To perform this comparison, the behavior information must first be obtained.

The manner of obtaining behavior information for members of both the test group and the control group may vary from implementation to implementation. For example, if the goal of a marketing effort is for users to visit a particular online site, behavior detection may involve monitoring which users visit that site. On the other hand, if the goal of the marketing effort is to sell a particular product online, behavior information may be obtained by monitoring which users visit the sales page of the product, and which of those users actually make a purchase.

In a situation where the goal of the marketing effort is for users to download a particular application, download request information from an application store may be inspected to obtain behavior information. If the goal of the marketing effort is for users to watch a particular television show, set-top boxes may be configured to send the effectiveness testing service information about what shows users are watching.

As another example, purchases made both online and offline may be reflected in credit card usage information. Consequently, the effectiveness testing service may use credit card usage information to compare the post-exposure purchase behavior of an exposed member to the purchase behavior of the corresponding unexposed twin.

As yet another example, members of the test and control groups may be asked to participate in a surveys relating to a product or service to which the marketing effort is directed. In the case of surveys, differences between a test group member's answers the survey questions and the answers given by that member's unexposed twin may be an indication of the effectiveness of the marketing efforts.

In an online environment, detected exposure may automatically trigger immediate behavior assessment actions. For example, in response to detecting that a user has been exposed to a particular online advertisement, the effectiveness testing service may immediately invite both the exposed member and the exposed member's unexposed twin to participate in a survey. Such automatically-triggered survey invitations may take many forms. For example, email messages that invite the users to participate in a survey may be sent to the exposed member and the unexposed twin immediately in response to the exposure. Instead of or in addition to email, the automatically-triggered survey invitations may take the form of instant messages, SMS text messages, or even physical invitations sent by “snail mail”.

The examples given herein of how behavior information may be obtained are not exhaustive, and the techniques used herein are not limited to any particular mechanisms for obtaining behavior information.

### Alternative Distance Determining Techniques

This N-Dimensional distance calculation for finding the nearest neighbor can be thought of as a Euclidean or Manhattan distance problem. Consequently, the space-locations and corresponding distances may be determined using any technique developed for solving Euclidean or Manhattan distance problems. Various techniques for finding the “Nearest Neighbor Match” are described, for example, at en.wikipedia.org/wiki/Nearest_neighbor_search.

In the example illustrated in FIG. 2, attributes are given significantly different weights based on their position within the concatenated space-location value. In alternative embodiments, attributes may be given the same or similar weights. For example, Random Iterative Method (RIM) weighting and/or iterative proportional fitting techniques may be used to establish a more sophisticated relative weighting between the attributes that correspond to the N-dimensions. RIM weighting and Iterative proportional fitting are described at en.wikipedia.org/wiki/Iterative_proportional_fitting.

In one embodiment, rather than treat each characteristic as a separate dimension, data reduction techniques may be applied so that the number of dimensions (N) is less than the number of individual attributes. Data reduction may involve using Principle Component Analysis (PCA) to reduce a large amount of variables to a smaller amount of dimensions. For example, thousands of “sites visited” attributes may be reduced to 20 values that contain a high percentage (e.g. 90%) of the predictive power of the thousands of “sites visited” attributes. In this case, the 20 values, rather than the thousands of attributes, are treated as dimensions for the purpose of determining the space-locations of users. Principle Component Analysis is described, for example, in Abdi. H., & Williams, L. J. (2010). “Principal component analysis.” Wiley Interdisciplinary Reviews Computational Statistics, 2: 433-459.

In one embodiment, all or a subset of the attributes are reduced to a single “propensity score”, where the propensity score is the variable that is determined to have the highest predictive power among the variables generated from the attributes produced using PCA. Propensity Score Matching is described at en.wikipedia.org/wiki/Propensity_score_matching. In the case where the values of all user attributes are reduced to a single propensity score, the propensity score of a user constitutes the location of user within the N-Dimensional Space.

### Pooled Matching

The examples given above related to a “paired” matching approach, where for any given exposed user in the test group, one unexposed twin is added to the control group. In an alternative embodiment, a “pooled” matching approach may be used. In a pooled matching approach, rather than find an “unexposed twin” for each individual in the test group, a control group is chosen such that the aggregated attributes of the control group match the aggregated characteristics of the test group.

For example, assume that the aggregate attributes of the test group are 20% male, 5% in age group 0-19, 95% in age group 20-49, 50% frequent users of service X, 30% with children, etc. A control group for such a test group may be established by selecting control group members which, when their attributes are aggregated, closely match the aggregated characteristics of the test group. In the present example, the aggregate attributes of the ideal control group would also be 20% male, 5% in age group 0-19, 95% in age group 20-49, 50% frequent users of service X, 30% with children, etc. This may be the case even though the specific combinations of attributes possessed by the test group members may be significantly different than the specific combinations of attributes possessed by the control group members.

While pre-calculating the control group matches for all possible test groups would not be practical, it is possible to perform mini-pooled matches in near real time. For example, in one embodiment, the effectiveness testing service may wait until three members of the community have been exposed to the marketing efforts. Once three panelists have been exposed, the aggregated attributes of the three-person pool may be used to find a corresponding three-person pool of unexposed members to use as the control group.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

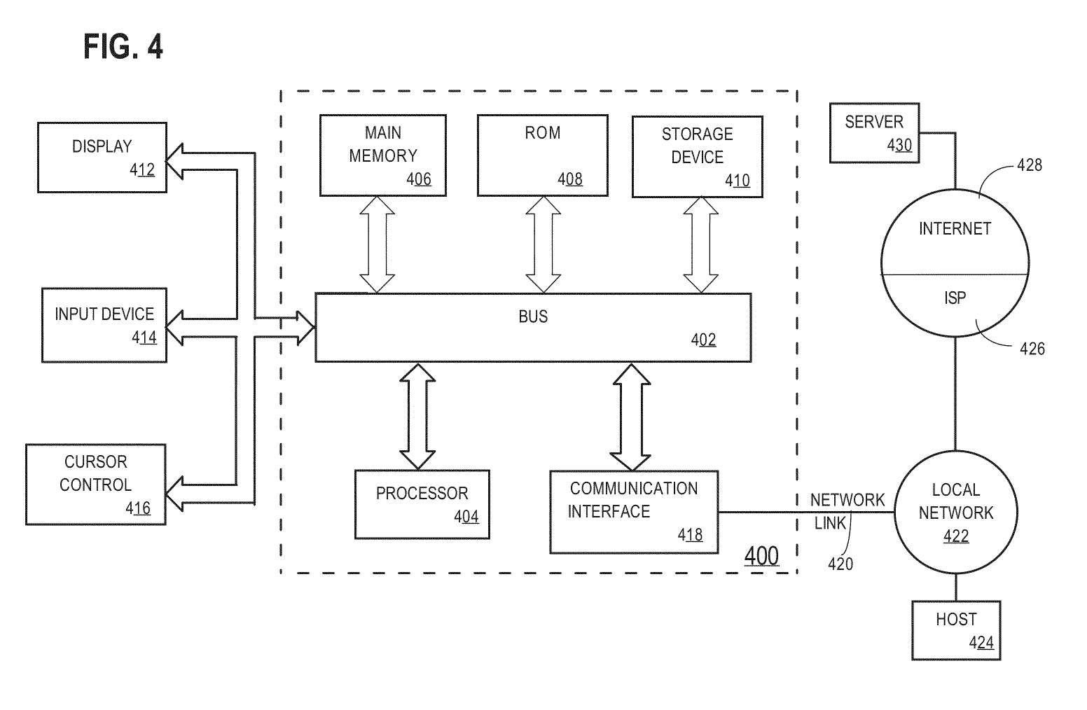

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
generating space-location data that indicates a space-location for each member of a population in an N-Dimensional Space defined by attributes of the members;
after the space-location data has been generated, performing the steps of
detecting that a first member of a population has been exposed to marketing efforts whose effectiveness is subject to a test;
in response to detecting that the first member has been exposed to the marketing efforts, performing the steps of
adding the first member to the test group of the test;
adding an unexposed twin of the first member to the control group for the test; and
comparing post-exposure behavior information of members of the test group with behavior information of members of the control group;
wherein the unexposed twin of the first member is a second member of the population that (a) was not exposed to the marketing efforts, and (b) is selected as the unexposed twin of the first member based on how close the space-location of the second member is to the space-location of the first member;
wherein the method is performed by one or more computing devices.

2. The method of claim 1 wherein generating space-location data includes:
generating distance data by calculating a distance between the space-location of each member of the population and the space-location of each other member of the population; and
based on the distance data, storing neighbor data that indicates, for each member of the population, one or more closest neighbors to the member within the N-Dimensional Space;
wherein the unexposed twin of the first member is selected based on the neighbor data that is stored for the first member.

3. The method of claim 1 wherein generating space-location data includes:
mapping a plurality of attributes values of the first member to integer coordinates; and
combining the integer coordinates to generate the space-location for the first member.

4. The method of claim 3 wherein combining the integer coordinates includes concatenating the integer coordinates in an order that is based on relative significance of attributes to which the integer coordinates correspond.

5. The method of claim 1 wherein:
the marketing efforts include an online advertisement; and
the method further comprises using a tag associated with the online advertisement to detect that the first member has been exposed to the online advertisement.

6. The method of claim 5 further comprising automatically performing an action to obtain behavior information from the first user and the second user in response to detecting that the first user was exposed to the online advertisement.

7. The method of claim 6 wherein the action includes sending email invitations to participate in a survey to both the first user and the second user.

8. The method of claim 1 wherein comparing post-exposure behavior information of members of the test group with behavior information of members of the control group includes comparing purchase behavior information of the first user with purchase behavior information of the second user.

9. The method of claim 1 wherein comparing post-exposure behavior information of members of the test group with behavior information of members of the control group includes comparing viewing behavior information of the first user with viewing behavior information of the second user.

10. The method of claim 1 wherein:
a particular set of dimensions of the N-Dimensional space correspond to a particular set of attributes of the members;
wherein the number of attributes in the particular set of attributes is greater than the number of dimensions in the particular set of dimensions; and
the method includes using principle component analysis to reduce values for the particular set of attributes to values for the particular set of dimensions.

11. The method of claim 1 wherein the attributes of the members that are used to determine the space-location of each member include at least one demographic attribute and at least one behavioral attribute.

12. The method of claim 11 wherein the at least one behavioral attribute includes an attribute that is based on usage of a particular online site.

13. The method of claim 1 wherein the attributes of the members that are used to determine the space-location of each member include at least one of: age, gender, marital status, or number of children.

14. A non-transitory computer readable medium storing instructions which, when executed by one or more processors, cause performance of a method comprising:
generating space-location data that indicates a space-location for each member of a population in an N-Dimensional Space defined by attributes of the members;
after the space-location data has been generated, performing the steps of
detecting that a first member of a population has been exposed to marketing efforts whose effectiveness is subject to a test;
in response to detecting that the first member has been exposed to the marketing efforts, performing the steps of
adding the first member to the test group of the test;
adding an unexposed twin of the first member to the control group for the test; and
comparing post-exposure behavior information of members of the test group with behavior information of members of the control group;
wherein the unexposed twin of the first member is a second member of the population that (a) was not exposed to the marketing efforts, and (b) is selected as the unexposed twin of the first member based on how close the space-location of the second member is to the space-location of the first member;
wherein the method is performed by one or more computing devices.

15. The non-transitory computer readable medium of claim 14 wherein generating space-location data includes:
generating distance data by calculating a distance between the space-location of each member of the population and the space-location of each other member of the population; and
based on the distance data, storing neighbor data that indicates, for each member of the population, one or more closest neighbors to the member within the N-Dimensional Space;
wherein the unexposed twin of the first member is selected based on the neighbor data that is stored for the first member.

16. The non-transitory computer readable medium of claim 14 wherein generating space-location data includes:
mapping a plurality of attributes values of the first member to integer coordinates; and
combining the integer coordinates to generate the space-location for the first member.

17. The non-transitory computer readable medium of claim 16 wherein combining the integer coordinates includes concatenating the integer coordinates in an order that is based on relative significance of attributes to which the integer coordinates correspond.

18. The non-transitory computer readable medium of claim 14 wherein:
the marketing efforts include an online advertisement; and
the method further comprises using a tag associated with the online advertisement to detect that the first member has been exposed to the online advertisement.

19. The non-transitory computer readable medium of claim 18 wherein the method further comprises automatically performing an action to obtain behavior information from the first user and the second user in response to detecting that the first user was exposed to the online advertisement.

20. The non-transitory computer readable medium of claim 19 wherein the action includes sending email invitations to participate in a survey to both the first user and the second user.

21. The non-transitory computer readable medium of claim 14 wherein comparing post-exposure behavior information of members of the test group with behavior information of members of the control group includes comparing purchase behavior information of the first user with purchase behavior information of the second user.

22. The non-transitory computer readable medium of claim 14 wherein comparing post-exposure behavior information of members of the test group with behavior information of members of the control group includes comparing viewing behavior information of the first user with viewing behavior information of the second user.

23. The non-transitory computer readable medium of claim 14 wherein:
a particular set of dimensions of the N-Dimensional space correspond to a particular set of attributes of the members;
wherein the number of attributes in the particular set of attributes is greater than the number of dimensions in the particular set of dimensions; and
the method includes using principle component analysis to reduce values for the particular set of attributes to values for the particular set of dimensions.

24. The non-transitory computer readable medium of claim 14 wherein the attributes of the members that are used to determine the space-location of each member include at least one demographic attribute and at least one behavioral attribute.

25. The non-transitory computer readable medium of claim 24 wherein the at least one behavioral attribute includes an attribute that is based on usage of a particular online site.

26. The non-transitory computer readable medium of claim 14 wherein the attributes of the members that are used to determine the space-location of each member include at least one of: age, gender, marital status, or number of children.
